(19) United States
(12) Patent Application Publication
(10) Pub. No.: US 2022/0242440 A1
(43) Pub. Date: Aug. 4, 2022

(54) METHODS AND SYSTEM FOR GENERATING A LANE-LEVEL MAP FOR AN AREA OF INTEREST FOR NAVIGATION OF AN AUTONOMOUS VEHICLE

(71) Applicant: Argo AI, LLC, Pittsburgh, PA (US)

(72) Inventors: Zachary Kurtz, Pittsburgh, PA (US); Mauro Della Penna, San Francisco, CA (US)

(21) Appl. No.: 17/162,094

(22) Filed: Jan. 29, 2021

(51) Int. Cl. B60W 60/00; G01C 21/00; G01C 21/34; G01C 21/30

(52) U.S. Cl. CPC B60W 60/001; G01C 21/30; G01C 21/3407; G01C 21/3815

(57) ABSTRACT

Systems and methods for controlling navigation of an autonomous vehicle are disclosed. The system receives information relating to a geonet that represents a portion of a map area within which the autonomous vehicle is allowed to operate, and a lane-level map comprising a plurality of lane segments corresponding to the map area. For each of the plurality of lane segments, the system identifies a match geonet element from a plurality of geonet elements included in the geonet, determines a match distance between the match geonet element and that lane segment, and selects that lane segment for inclusion in the geonet upon determining that the match distance is less than a threshold distance. An updated lane-level map is generated using one or more lane segments selected for inclusion in the geonet for use by an autonomous vehicle to navigate between an origin location and a destination location within the geonet.

### BACKGROUND

Traditionally, transportation and related ride-share type commercial services have been provided by a human-operated vehicle. However, human operators may not choose to operate in an efficient manner. For example, human operators may not know of high demand areas, or demand trends, leading them to operate in lower demand areas. Additionally, human operators may prefer certain areas (such as areas close to home, areas to perform errands after rides, etc.) which may not lead to an efficient distribution of vehicles in a given region. Improvements in computer processing have led to increasing efforts to automate more of these services, using autonomous vehicles that do not require a human operator. For such services, it is often required to limit navigation of an autonomous vehicle to certain geographical areas. For example acceptable routes or mapped areas for navigation of autonomous vehicles may be selected based on, such as cost (e.g., cost per mile, cost per passenger, etc.), supply and demand (e.g., under-served or over-served regions, routes, etc.), accessibility (e.g., average speed, street grades, accident data, traffic data, etc.), route optimization (e.g., avoid high traffic area during certain times, avoid surface streets, etc.), traffic rules (e.g., whether or not autonomous vehicle are allowed in a location), safety (e.g., certain areas may be difficult for an autonomous vehicle to navigate, crime rates, etc.) and the like.

It is important that autonomous vehicles understand precisely where they are in space at all times. An autonomous vehicle, therefore, takes a pre-existing and detailed map—a high definition map, such as a vector maps—of its environment (often including lane segment level details) and projects its sensor data on top of it so the vehicle can have enough information to make the safe navigation decision. However, each such high definition map can include hundreds of thousands of lane segments such that it is not practically feasible to use the detailed high definition map for delineating the geographical areas in which an autonomous vehicle is allowed to operate. Instead, low definition maps such as navigation maps, road-level maps, or the like that include limited information are used to demarcate or select such areas. There is a need to associate the area within which an autonomous vehicle can operate and that is selected using a low definition map to a high definition map.

This document describes methods and systems that are directed to addressing the problems described above, and/or other issues.

### SUMMARY

In one or more scenarios, systems and methods for controlling navigation of an autonomous vehicle are disclosed. The system includes a processor and a non-transitory computer readable medium that includes one or more programming instructions that, when executed by a processor, will cause the processor to execute the methods of this disclosure. The system may receive information relating to a geonet that represents a portion of a map area within which an autonomous vehicle is allowed to operate, and a lane-level map that includes a plurality of lane segments corresponding to the map area. The geonet may include a plurality of geo-coordinate pairs that are each indicative of a start location and an end location of a geonet element in the geonet. For each of the plurality of lane segments, the system may identify a match geonet element from the plurality of geonet elements, determine a match distance between the match geonet element and that lane segment, and select that lane segment for inclusion in the geonet upon determining that the match distance is less than a threshold distance. The system may then generate an updated lane-level map that includes the geonet using one or more lane segments selected for inclusion in the geonet, and cause the autonomous vehicle to navigate between an origin location and a destination location within the geonet by generating, using the updated lane-level map, a trajectory between the origin location and the destination location. Optionally, each of the plurality of lane segments may be represented as a polygon within the lane-level map.

In certain implementations, the system may create a data representation of the geonet that includes an indication of the one or more lane segments selected for inclusion in the geonet, and add the data representation to a low definition map comprising the geonet for creation of the updated lane-level map within the low definition map.

The system may identify the match geonet element from the plurality of geonet elements for a lane segment by identifying a geo-coordinate that forms a mid-point of that lane segment. Optionally, the system may then identify a plurality of candidate geonet elements that are within a first threshold distance of that lane segment use a spatial search algorithm, determine a candidate match distance between each of the plurality of candidate geonet elements and that lane segment, identify a candidate geonet element of the plurality of candidate geonet elements that has the least candidate match distance, and determine that the candidate geonet element is the match geonet element. The system may, optionally, determine the candidate match distance between each of the plurality of candidate geonet elements and that lane segment by determining the candidate match distance for a candidate geonet element as an average of: an angular distance between a centerline of that lane segment and that candidate geonet element, a perpendicular distance between the geo-coordinate of that lane segment and an infinite line defined by that geonet element, and a lengthwise minimum distance along a line computed as the projection of the geo-coordinate of that lane segment onto the infinite line defined by that geonet element to each of that geonet element's endpoints.

In some implementations, the system may cluster the one or more lane segments selected for inclusion in the geonet into logical groupings that form a plurality of undirected streets. For each such undirected street, the system may determine a median match distance as an average of match distances of all the lane segments that form that street, determine whether the median match distance is greater than a second threshold distance, and determine that all the lane segments that form that street should not be included in the geonet when the median match distance is greater than the second threshold distance. When the median match distance is less than the second threshold distance, the system may determine that all the lane segments that form that street will be included in the geonet. Optionally, the system may cluster the one or more lane segments selected for inclusion in the geonet into logical groupings that form the plurality of undirected streets by, for example, merging one or more lane segments to create road segments, replacing one or more lane segments with a single lane required to span a street perpendicular to traffic, and/or merging merge road segments parallel with traffic.

In at least one implementation, the system may also identify a subset of the one or more lane segments selected for inclusion in the geonet as strongly connected lane segments by creating a routing graph using the one or more lane segments selected for inclusion in the geonet, and identifying a strongly connected component of the routing graph, and using only the identified subset for generating the updated lane-level map.

### BRIEF DESCRIPTION OF THE DRAWINGS

FIG. 1 illustrates a flow chart of an example method of generating a lane-level map for an area of interest for navigation of an autonomous vehicle.

FIG. 2 illustrates an example representation of a geonet.

FIG. 3 illustrates an example representation of a lane-level map.

FIG. 4 illustrates an example representation of an updated lane-level map including the geonet of FIG. 2 and corresponding lane segments.

FIG. 5 is an example representation of streets formed by grouping of lane segments.

FIG. 6 is a block diagram illustrating an example autonomous vehicle system.

FIG. 7 illustrates an example vehicle controller system.

FIG. 8 is a block diagram that illustrates various elements of a possible electronic system, subsystem, controller and/or other component of an AV, and/or external electronic device.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

Due to the limited accuracy of a low definition map (e.g., a road-level map), a route generated using low definition maps does not typically include a specific trajectory that an autonomous vehicle can follow. While such guidance may be accurate for human drivers, in order to drive autonomously, an autonomous vehicle often requires more knowledge about the exact positions where the vehicle should continue going straight, turn, etc. they still do not generally contain the kinds of detail that we need. For example, an autonomous vehicle needs to know the left and right boundary of each lane, whereas road level maps typically only provide something approximating the road centerline. As a result, autonomous vehicles supported by road-level navigation must be equipped with a powerful real-time perception and motion planning system, which greatly increases the on-board computational burden. In contrast, lane-level navigation is able to provide a reference trajectory that can actually be followed by an autonomous vehicle in the absence of other vehicles or obstacles. The key difference between lane-level navigation and road-level navigation is the ability of the former to provide an exact trajectory as the input of control, without the help of an environment perception system. Although a lane-level navigation system cannot replace a real-time perception and motion planning system, it can greatly release its computation burden and reduce the risk of system failure.

Furthermore, as discussed above, operation of an autonomous vehicle may be restricted to certain mapped areas in an environment for several reasons. Such areas may need to be identified frequently and/or quickly on a regular basis, and it is not feasible to use high definition maps for performing the area selection. Instead, such areas are typically identified by selecting road segments, coordinates, and/or regions within a low definition map (e.g., navigational maps, road level maps). Such low definition maps are usually designed to assist human drivers and do not include information such as lane level accuracy, lane level geometry, or the like that is needed for navigating an autonomous vehicle (e.g., during route planning, perception, prediction, motion planning, etc.). In contrast, a lane-level map includes a lane-level road network, lane-level attribution in detail, and lane geometry lines with high accuracy (e.g., decimeter level) modeling the real world. It should be noted that a road in a lane-level map typically includes one or more adjacent lanes, which may be divided by lane markings and are intended for a single line of traffic. Lanes may be split longitudinally at lane segments, sometimes at locations meaningful for motion planning (such as the start/end of an intersection) and/or at other locations that may not be meaningful for motion planning as an artifact of the map generation process. Certain lane segments may also be clustered to form streets as described below.

This document describes an automated method for associating an area selected within a low definition map to a high definition map. Such association of the selected area may allow an autonomous vehicle to identify lane segments within a high definition map that are required to support navigation and/or services (e.g., taxi services, rideshare trips, etc.) between two points within the selected area. The route planning system of the autonomous vehicle may then use the identified lane segments for generating one or more trajectories for navigating the autonomous vehicle, without additional on-board computational burden.

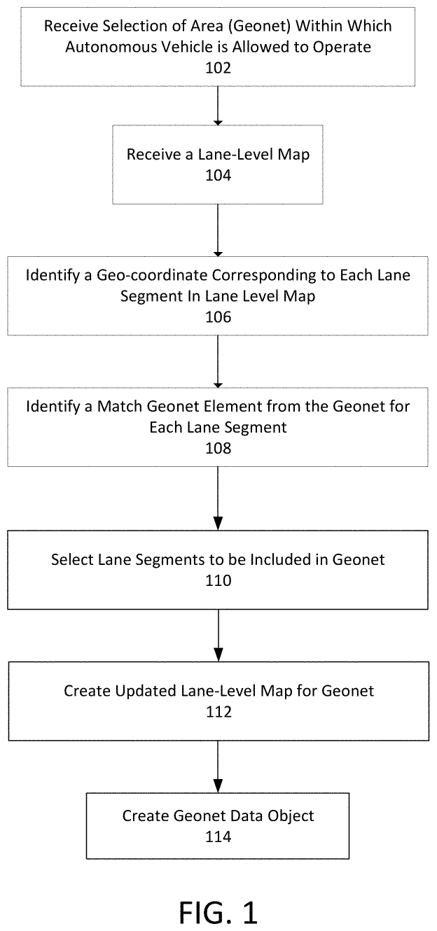

FIG. 1 illustrates a flow chart of an example method of generating a lane-level map for an area of interest for navigation of an autonomous vehicle. As shown in FIG. 1, a system may receive 102 a selection of an area within which the autonomous vehicle is allowed to operate. The system may receive the area selection from a user and/or may automatically select the area based on information such as cost optimization, demand and supply optimization, accessibility, traffic rules, route optimization, passenger safety, or the like.

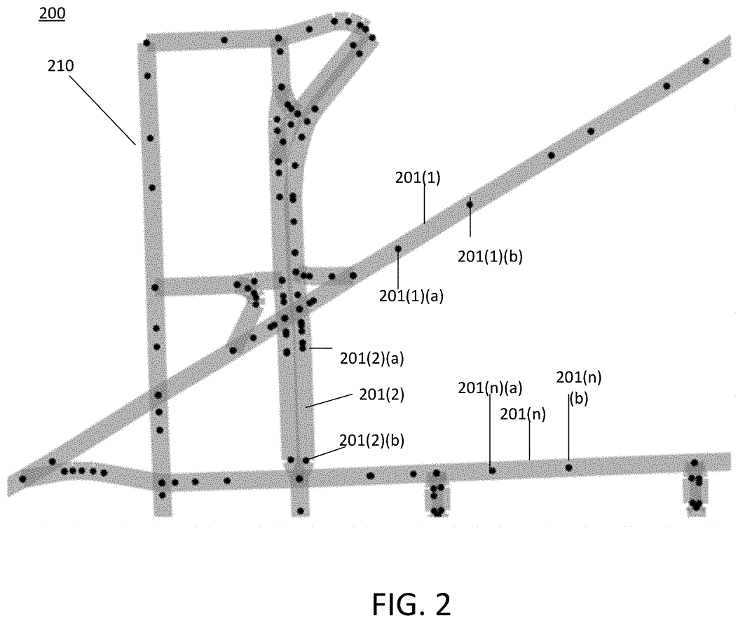

In various implementations, the selected area in the form of a geonet. The term “geonet”, as used herein, refers to a collection of geo-coordinate pairs that indicate approximate starting and ending locations of short road segments (typically less than 500 m)—subsequently referred to as geonet elements—that together form the selected area within the road-network map. An example road network map 200 including a geonet 210 is shown in FIG. 2. The geonet 210 is formed from road segments 201(1), 201(2) . . . 201(n) (i.e., geonet elements and illustrated using grey rectangles) between respective starting and ending locations 201(1)(a)-201(1)(b), 201(2)(a)-201(2)(b) . . . 201(n)(a)-201(n)(b) (illustrated using black circles) is also shown.

The system may, optionally, receive the selection of the area within a low definition map (e.g., a road-network map) of an environment of the autonomous vehicle. The system may receive the low definition map from a data store such as, for example, a map data store. At least a portion of map and/or the selected area may be stored in memory onboard of an autonomous vehicle, may be accessed from a remote electronic device (e.g., a remote server), may be transmitted to an autonomous vehicle via a traffic node positioned in the area in which the vehicle is traveling, may be transmitted to an autonomous vehicle from one or more sensors, and/or the like.

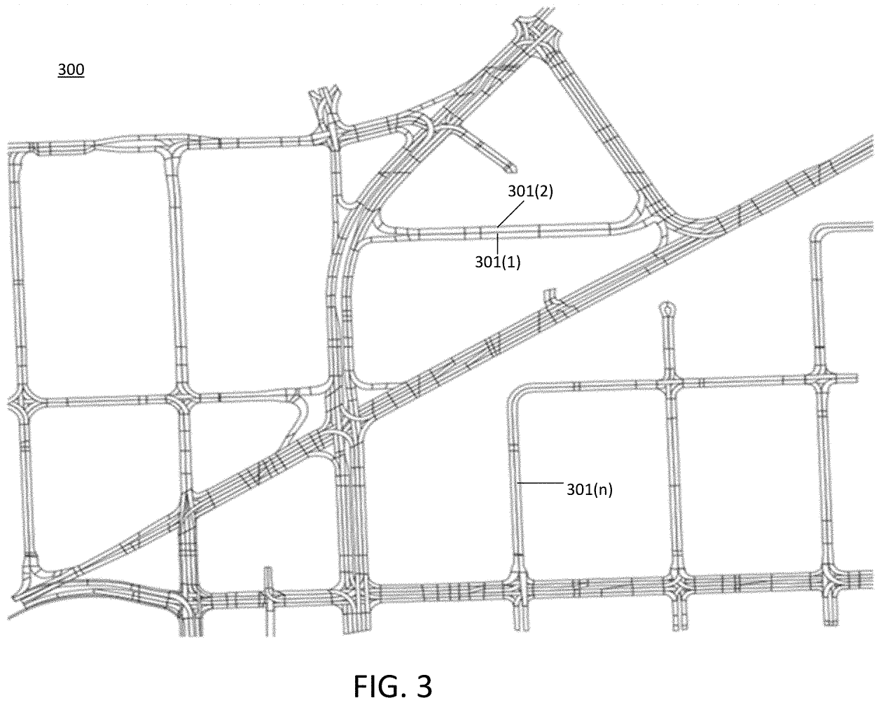

At 104, the system may also receive a lane-level map corresponding to at least a portion of the low definition map within the environment of the autonomous vehicle. The system may receive the lane-level map from a data store such as, for example, a map data store. The lane-level map may include a plurality of lane segments as a collection of closed polygons that define sections of the mapped roadways within the environment. As used in this disclosure, a “polygon” refers to a mapping construct that is associated with a section of a road. For example, FIG. 3 illustrates an example lane-level map 300 including a plurality of lane segments 301(1), 301(2) . . . 301(n) (shown as white polygons).

At least a portion of the lane-level map may be stored in memory onboard of an autonomous vehicle, may be accessed from a remote electronic device (e.g., a remote server), may be transmitted to an autonomous vehicle via a traffic node positioned in the area in which the vehicle is traveling, may be transmitted to an autonomous vehicle from one or more sensors, and/or the like.

Referring back to FIG. 1, the system may identify (106) a geo-coordinate corresponding to each lane segment in the lane-level map. In certain implementations, the lane segment geo-coordinate may be an approximate mid-point within the polygon that forms the lane segment. The system may identify the approximate middle point by, for example, computing a centerline (e.g., a line that is equidistant from and parallel to two opposing edges of a lane segment) that passes approximately through the middle of the lane segment, and identify the mid-point of the centerline as the mid-point of the lane segment. Optionally, the system may identify the approximate middle point as an intersection of two centerlines within the polygon that forms the lane segment. In various embodiments, the system may store information pertaining to the geo-coordinates corresponding to the lane segments in one or more data stores. This information may include, for example, an identifier associated with a lane segment, the starting and ending location of the lane segment, information about the geo-coordinate, and/or the like.

At 108, the system may identify a match geonet element within the geonet for each lane segment within the lane-level map. In various implementations, the match geonet element may be the closest geonet element to a lane segment.

The system may identify the match geonet element by first identifying a subset of candidate geonet elements (e.g., 4 geonet elements, 5 geonet elements, 6 geonet elements, etc.) within the geonet that are within a threshold distance of a lane segment. Alternatively and/or additionally, the system may identify a subset of candidate geonet elements that are closest to a lane segment. The system may identify the subset of the candidate geonet elements using, for example, spatial search algorithms such as a KD-tree, K-nearest neighbors, R-tree, or the like. In certain examples, the system may identify the subset of candidate geonet elements for a lane segment by analyzing, using a spatial search algorithm, distances between the lane segment geo-coordinate and one or more points on the geonet element. Examples of such points may include, without limitation, a first geo-coordinate that forms a starting location of the geonet element, a second geo-coordinate that forms an ending location of the geonet, a midpoint of the geonet element, and/or any other suitable point on that geonet element. Optionally, the system may identify, for each geonet element, the minimum distance of all the distances between the lane segment geo-coordinate and various points on that geonet element. The system may then analyze, using a spatial search algorithm, the determined minimum distances of the geonet elements to identify the subset of candidate geonet elements.

The system may then analyze each candidate geonet element within the identified subset (for a lane segment) to select the match geonet element for that lane segment (e.g., as the geonet element that is closest to the lane segment). The system may identify the match geonet element by analyzing various characteristics of each candidate geonet element. Examples of such characteristics may include, without limitation: (i) an angle/angular distance between the lane segment centerline and each geonet element; (ii) a perpendicular distance between the geo-coordinate of the lane segment (e.g., centerline mid-point) and an infinite line defined by each geonet element; (iii) a lengthwise distance which is a minimum distance along a line computed as the projection of the geo-coordinate of lane segment onto the [infinite] line defined by a geonet element to each of the geonet element endpoints (if the projection lies within the geonet element, the system may replace the minimum with 0); and/or the like.

In certain implementations, the system may compute a candidate match distance between each geonet element in the subset of candidate geonet elements and the lane segment as a relationship between (i), (ii), and (iii) (e.g., an average, a sum, a weighted sum, or the like), and select a match geonet element for a lane segment that has the least candidate match distance from that lane segment. The match distance for a lane segment is the candidate match distance computed for the identified match geonet element for that lane segment. The angular distance between the centerline of a lane segment and a geonet element is the largest when the lane segment is aligned perpendicular to a given geonet element. As such, the preference given to a geonet element for selection as the match geonet element may be inversely proportional to the angular distance between the centerline of a lane segment and the geonet element, and the system may preferentially select a match geonet element (from the subset) that is parallel to the lane segment and/or has a relatively small angular distance. Analysis of the perpendicular distance between the geo-coordinate of the lane segment (e.g., centerline mid-point) and an infinite line defined by a geonet element may be used by the system (in combination with the angular distance) to avoid selecting a candidate geonet element as a match geonet element that is far from the lane segment but has a relatively small angular distance (e.g., close to zero or zero). The lengthwise distance may be used by the system to avoid selecting candidate geonet elements as a match geonet element where a lane segment that is far from the lane segment but has relatively small angular distance and perpendicular distance (e.g., close to zero or zero). It should be noted that one or more lane segments may have the same match geonet element.

At 110, the system may analyze the lane segments in the lane-level map to select lane segments that should be included within the geonet. The system may only include lane segments in the geonet that are within a threshold distance of the corresponding match geonet element. For example, the system may analyze the match distance (discussed above) for each lane segment and only include lane segments whose match distance is less than the threshold in the geonet. The threshold distance may be received from a user and/or may be determined experimentally by analyzing output geonets matched to one or more lane segments, and determining whether or not they correspond to a target region.

In certain implementations, the system may further refine the lane segment selection for inclusion in the geonet in order to avoid selection of lane segments with inaccurate match geonet elements when, for example, a lane segment includes a lane curvature, there are clusters of large numbers of small geonet elements very close to the same lane segment, or the like. The system may refine the lane segment selection by clustering the lane segment into undirected streets to create logical groupings of lane segments such that the system may either include all the lane segments that form an undirected street into the geonet or discard all the lane segments that form the undirected street. Typically, lane segments clustered to form an undirected street should have the same match geonet element.

The system may cluster lane segments into undirected streets using, for example, adjacency and successor-predecessor relationships within the lane segments of the lane-level map. For example, the system may merge lane segments “across traffic” to create road segments, replace several lane segments with a single lane required to span a street (perpendicular to traffic, and/or merge road segments parallel with traffic (where possible, while keeping merged segments free of “forks”). For example, the system may cluster lane segments included in a stretch of roadway between two intersections into a single undirected street. Any other now or hereafter known methods may also be used to create such lane segment clustering.

The system may then identify the match distance (as discussed above) for each of the lane segments that are clustered together to form an undirected street, and determine a median match distance for that undirected street. If the median threshold for a street exceeds a threshold, the system may discard all the lane segments that are clustered to form that street from inclusion within the geonet. However, if the median threshold for a street is less than or equal to the threshold, the system may include all the lane segments in that street into the geonet. The threshold distance may be received from a user and/or may be determined experimentally by analyzing output geonets matched to one or more lane segments, and determining whether or not they correspond to a target region.

Analysis of the median match distance to discard lane segment clusters may increase the accuracy of lane segment selection for lane segments that form a street by sharing information across lane segments. This is particularly important when, for example, when individual lane segments that form a street do not uniformly match with the same geonet element. This may happen in situations such as when, for example, a street is mostly straight but ends with a sharp turn, and the lane segment at the turn may not have the same match geonet element as the other lane segments in the street (because of its angular distance).

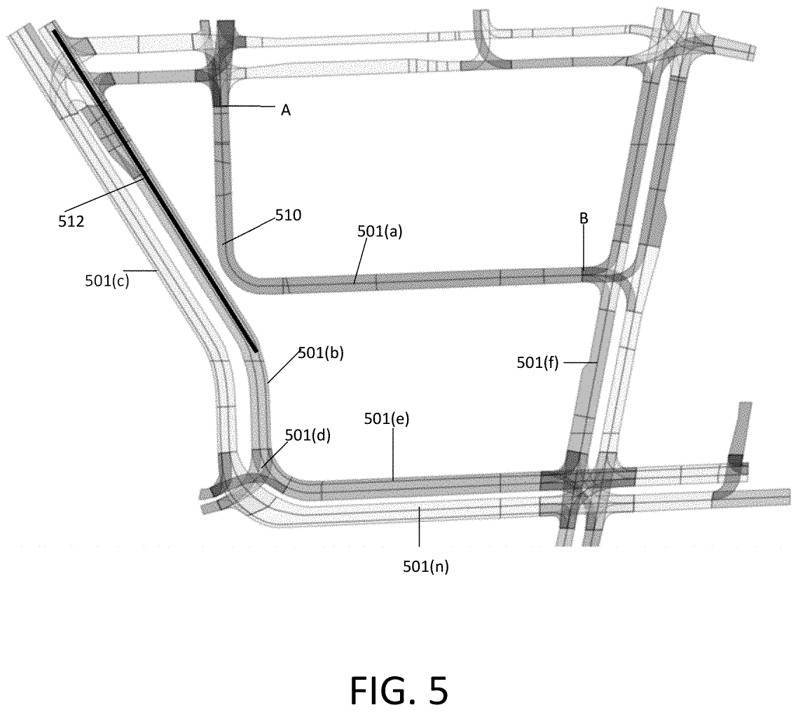

FIG. 5 illustrates example streets 501(a), 501(b), 501(c), 501(d), 501(e), 501(f) . . . 501(n) formed by merging multiple road segments as discussed above. As discussed, such grouping of lane segments prevents matching of lane segments with unrelated geonets. For example, as shown in FIG. 5, grouping lane segment 510 in the street 501(a) between points A and B prevents matching of the lane segment with neighboring geonet element 512.

Optionally, the system may further select lane segments to be included in the geonet using connectivity of lane segments to each other, and may only select a lane segment set that is strongly connected for inclusion in the geonet. A lane segment set is strongly connected if it is possible to find a route that leads from lane segment A to lane segment B for every pair (A, B) in the set of lane segments. Strong connectivity, as used herein, refers to a property of a *set* (or graph) such that any graph X can be partitioned into disjoint subgraphs that are strongly connected, also known as strongly connected components (SCCs). Specifically, if SCC(X) denotes the largest strongly connected component of X, then a lane segment is not strongly connect with respect to X whenever the segment is not in SCC(X).

The system may, therefore, delineate the strongly connected lane segments by, for example, discarding and/or otherwise distinctly identifying the lane segments that are not strongly connected using any now or hereafter know methods (e.g., different colors, different greyscale shades, different naming conventions, or the like). Selection of the strongly connected lane segments may reduce the likelihood that an autonomous vehicle will become stranded, while traversing a trajectory, with no feasible route back to a destination/origination point. Moreover, selection of strongly connected lane segments may eliminate dead-end lane segments. Additionally and/or alternatively, such a selection may also reduce the size of the set of lane segments to be included in the geonet, consequently reducing the development and maintenance costs associated with the geonet.

The system may identify lane segments that are not strongly connected by constructing a lane-level routing graph corresponding to the geonet using the lane segments determined to be included in the geonet. The system may construct the routing graph by, for example, using each lane segment as a node and representing the option to proceed from one lane segment to its neighboring lane segment as a directed edge.

In various embodiments, the system may store information pertaining to the selected lane segments (from the lane level map) in one or more data stores. This information may include, for example, an identifier associated with a selected lane segment, corresponding match geonet element (s), the starting and ending location of the lane segment, an identifier of a corresponding street, match distance, and/or the like. Optionally, the system may output such information to, for example, a map generation application, a user, an autonomous vehicle, or the like.

At 112, the system may use the selected lane segments determined to be included in the geonet to create an updated lane-level map (corresponding to the received geonet) that includes the selected lane segments and corresponding match geonet elements. The system may create the updated lane-level map by, for example, aligning the selected lane segments and/or streets with the corresponding match geonet elements.

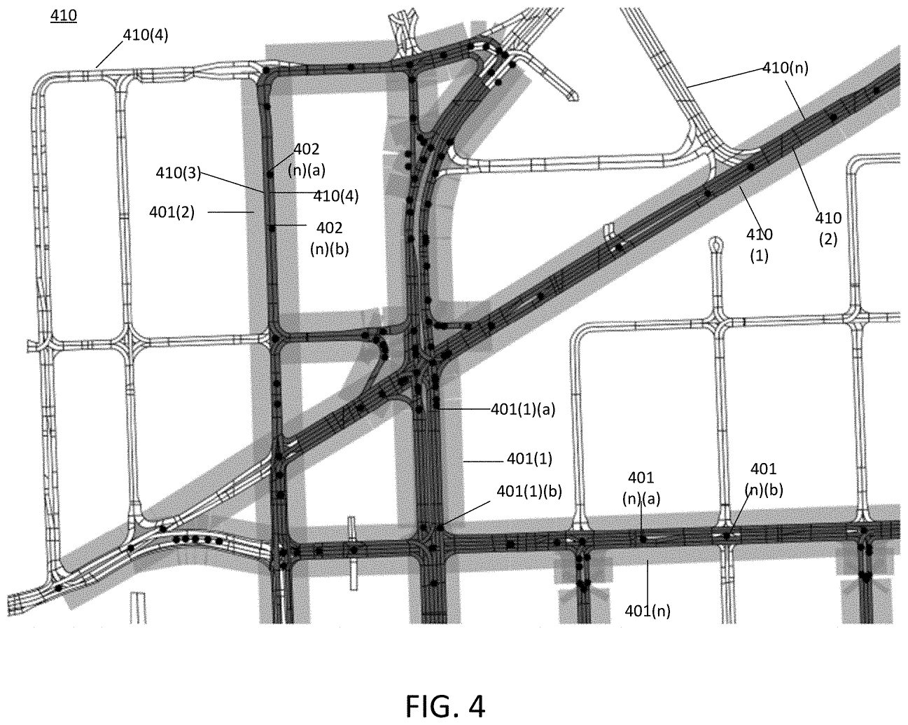

FIG. 4 illustrates an example updated lane-level map 410 including the received geonet (including example geonet elements 401(1), 401(2) . . . 401(n) (illustrated using grey rectangles) between respective starting and ending locations 401(1)(a)-401(1)(b), 401(2)(a)-401(2)(b) . . . 401(n)(a)-401(n)(b) (illustrated using black circles)) combined with the received lane level map including the lane segments 410(1), 410(2) . . . 410(n). The geonet may be combined with the lane-level map by, for example, superimposing and/or aligning at least the selected lane segments with the match geonet elements of the geonet. For example, FIG. 4 shows the selected lane segments of the lane level map superimposed over and/or aligned with the match geonet elements in the geonet. Optionally, lane segments that are not strongly connected may also be shown as superimposed over and/or aligned with the match geonet elements in the geonet. In such embodiments, amongst the lane segments superimposed over the geonet, certain lane segments may be illustrated as strongly connected lane segments (e.g., lane segments shown using grey color polygons), whereas the lane segments that are not strongly connected may be shown as, for example, a white color. Other representations (e.g., different colors, hatched patterns, etc.) of selected lane segments, non-selected lane segment, strongly connected lane segments, not strongly connected lane segments, match geonets, streets, etc. are within the scope of this disclosure.

Additionally and/or alternatively, as shown in FIG. 4, lane segments selected for inclusion in the geonet (i.e., that are matched to a geonet element) are illustrated using dark grey polygons, while the lane segments not selected for inclusion in the geonet are illustrated using white polygons. For example, as shown in FIG. 4, portions of grey lane segments 410(3) and 410(4) are superimposed over and aligned with corresponding matched geonet element 401(2).

It should be noted that the updated lane-level map may only include lane segments selected as corresponding to the geonet elements. For example, the lane segments not corresponding to the geonet may be deleted from FIG. 4. Optionally, as shown in FIG. 4, the updated lane-level map may include all or some additional lane segments from the lane-level map received by the system in addition to the lane segments corresponding to the geonet elements delineated/distinctly identified using any now or hereafter know methods (e.g., different colors, different greyscale shades, different naming conventions, superimposition over the geonet (as shown in FIG. 4), or the like.

In various embodiments, the system may create 114 a geonet data object for a geonet. Such a data object refers to a data representation of a geonet in terms of lane segments of the geonet. For example, a geonet data object may be a data structure or other data construct. The system may assign a unique identifier to the geonet data object. The unique identifier may be random or pseudo-randomly generated. Alternatively, the unique identifier may be sequentially or otherwise assigned by the system.

The system may add a listing of the lane segments that are included in the geonet in the geonet data object. The listing may include, for example, an identifier associated with each lane segment, starting and ending location of each lane segment, the match geonet element for each lane segment, match distance, whether or not the lane segment is strongly connected, street identifier and/or other information, information relating to other lane segments that are included in the same street as the lane segment, and/or the like. For instance, the system may assign a unique segment identifier each lane segment, and may add this unique lane segment identifier to the geonet data object.

In various embodiments, the system may store the geonet data object in one or more data stores such that it is accessible by one or more systems or subsystems of the autonomous vehicle such as, for example, a route planning system, a prediction system, a perception system, a motion planning system, and/or the like. The system may also add the geonet data object to one or more maps such as, for example, a road network map, a geonet map, etc. As such, when the map is loaded, information pertaining to the geonet data object (including, for example, selected lane segments of a lane-level map superimposed over and/or aligned with match geonet elements of a geonet) may be presented to a system user. For instance, the lane segments of a geonet may be visually displayed via one or more display devices. Other presentations of information pertaining to a geonet data object are contemplated within the scope of this disclosure.

The geonet data object may be used by an autonomous vehicle in a variety of ways. For example, a prediction system of an autonomous vehicle may use information within a geonet data object to accurately predict the behavior or trajectories of other objects within the geonet. As another example, a motion planning system of the autonomous vehicle may use information within a geonet data object to output an autonomous vehicle trajectory for traversing the geonet. For example, the autonomous vehicle may use the geonet object to avoid, prioritize, and/or use certain lane segments of a lane level map.

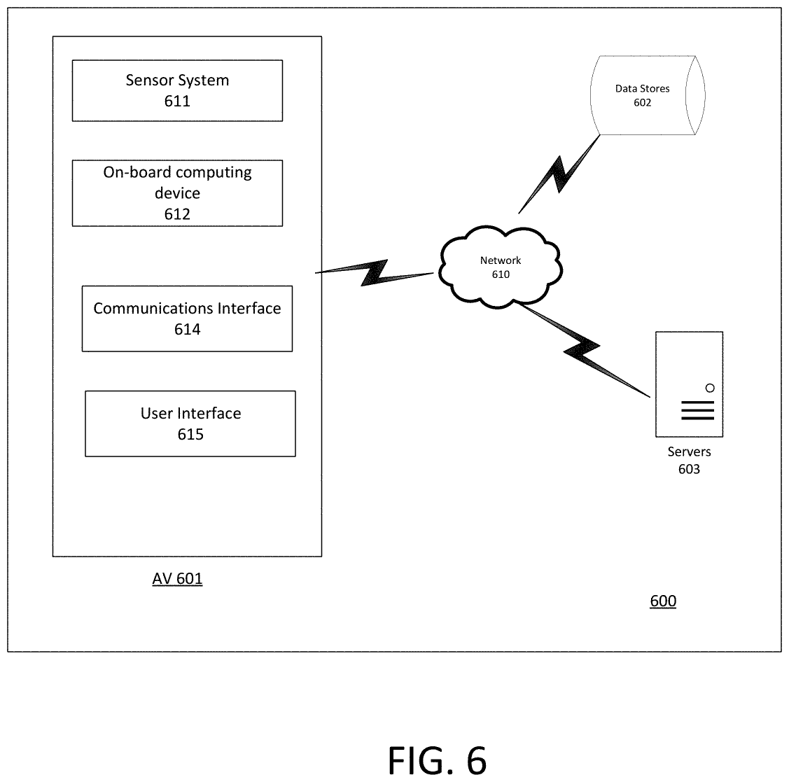

FIG. 6 is a block diagram illustrating an example system 600 that includes an autonomous vehicle 601 in communication with one or more data stores 602 and/or one or more servers 603 via a network 610. Although there is one autonomous vehicle shown, multiple autonomous vehicles may be coupled to each other and/or coupled to data stores 602 and/or servers 603 over network 610. Network 610 may be any type of network such as a local area network (LAN), a wide area network (WAN) such as the Internet, a cellular network, a satellite network, or a combination thereof, and may be wired or wireless. Data store(s) 602 may be any kind of data store such as, without limitation, map data store(s), traffic information data store(s), user information data store(s), point of interest data store(s), or any other type of content data store(s). Server(s) 603 may be any kind of servers or a cluster of servers, such as, without limitation, Web or cloud servers, application servers, backend servers, or a combination thereof.

As illustrated in FIG. 6, the autonomous vehicle 601 may include a sensor system 611, an on-board computing device 612, a communications interface 614, and a user interface 615. Autonomous vehicle 501 may further include certain components (as illustrated, for example, in FIG. 10) included in vehicles, such as, an engine, wheel, steering wheel, transmission, etc., which may be controlled by the on-board computing device 612 using a variety of communication signals and/or commands, such as, for example, acceleration signals or commands, deceleration signals or commands, steering signals or commands, braking signals or commands, etc.

The sensor system 611 may include one or more sensors that are coupled to and/or are included within the autonomous vehicle 601. Examples of such sensors include, without limitation, a LiDAR system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the autonomous vehicle 601, information about the environment itself, information about the motion of the autonomous vehicle 601, information about a route of the autonomous vehicle, or the like. As autonomous vehicle 601 travels over a surface, at least some of the sensors may collect data pertaining to the surface.

The LiDAR system may include a sensor configured to sense or detect objects and/or actors in an environment in which the autonomous vehicle 601 is located. Generally, LiDAR system is a device that incorporates optical remote sensing technology that can measure distance to a target and/or other properties of a target (e.g., a ground surface) by illuminating the target with light. As an example, the LiDAR system may include a laser source and/or laser scanner configured to emit laser pulses and a detector configured to receive reflections of the laser pulses. For example, the LiDAR system may include a laser range finder reflected by a rotating mirror, and the laser is scanned around a scene being digitized, in one, two, or more dimensions, gathering distance measurements at specified angle intervals. The LiDAR system, for example, may be configured to emit laser pulses as a beam. Optionally, the beam may be scanned to generate two dimensional or three dimensional range matrices. In an example, the range matrices may be used to determine distance to a given vehicle or surface by measuring time delay between transmission of a pulse and detection of a respective reflected signal. In some examples, more than one LiDAR system may be coupled to the first vehicle to scan a complete 360° horizon of the first vehicle. The LiDAR system may be configured to provide to the computing device a cloud of point data representing the surface(s), which have been hit by the laser. The points may be represented by the LiDAR system in terms of azimuth and elevation angles, in addition to range, which can be converted to (X, Y, Z) point data relative to a local coordinate frame attached to the vehicle. Additionally, the LiDAR may be configured to provide intensity values of the light or laser reflected off the surfaces that may be indicative of a surface type. In examples, the LiDAR system may include components such as light (e.g., laser) source, scanner and optics, photo-detector and receiver electronics, and position and navigation system. In an example, The LiDAR system may be configured to use ultraviolet (UV), visible, or infrared light to image objects and can be used with a wide range of targets, including non-metallic objects. In one example, a narrow laser beam can be used to map physical features of an object with high resolution.

It should be noted that the LiDAR systems for collecting data pertaining to the surface may be included in systems other than the autonomous vehicle 601 such as, without limitation, other vehicles (autonomous or driven), robots, satellites, etc.

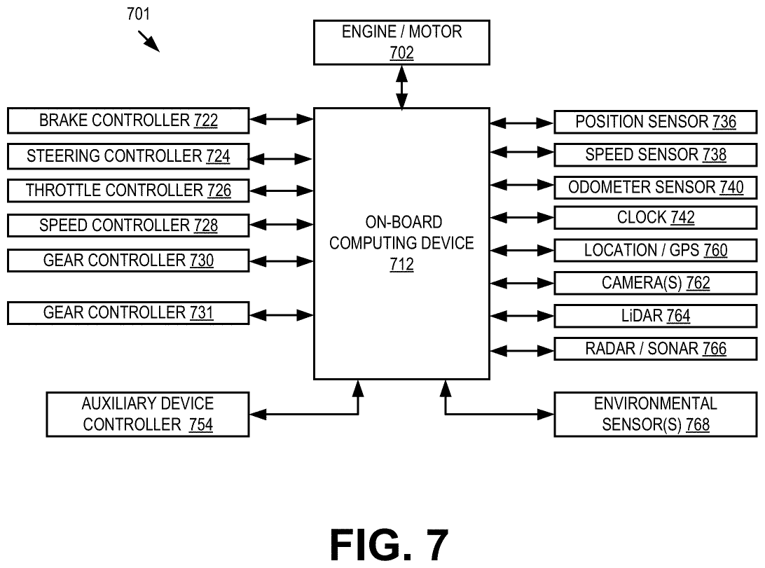

FIG. 7 illustrates an example system architecture for a vehicle 701, such as the autonomous vehicle 601 of FIG. 1 autonomous vehicle. The vehicle 701 may include an engine or motor 702 and various sensors for measuring various parameters of the vehicle and/or its environment. Operational parameter sensors that are common to both types of vehicles include, for example: a position sensor 736 such as an accelerometer, gyroscope and/or inertial measurement unit; a speed sensor 738; and an odometer sensor 740. The vehicle 701 also may have a clock 742 that the system architecture uses to determine vehicle time during operation. The clock 742 may be encoded into the vehicle on-board computing device 712. It may be a separate device, or multiple clocks may be available.

The vehicle 701 also may include various sensors that operate to gather information about the environment in which the vehicle is traveling. These sensors may include, for example: a location sensor 760 such as a GPS device; object detection sensors such as one or more cameras 762; a LiDAR sensor system 764; and/or a radar and or and/or a sonar system 767. The sensors also may include environmental sensors 768 such as a precipitation sensor and/or ambient temperature sensor. The object detection sensors may enable the vehicle 701 to detect objects that are within a given distance or range of the vehicle 701 in any direction, while the environmental sensors collect data about environmental conditions within the vehicle's area of travel. The system architecture will also include one or more cameras 762 for capturing images of the environment. Any or all of these sensors will capture sensor data that will enable one or more processors of the vehicle's on-board computing device 712 and/or external devices to execute programming instructions that enable the computing system to classify objects in the perception data, and all such sensors, processors and instructions may be considered to be the vehicle's perception system. The vehicle also may receive information from a communication device (such as a transceiver, a beacon and/or a smart phone) via one or more wireless communication link, such as those known as vehicle-to-vehicle, vehicle-to-object or other V2X communication links. The term “V2X” refers to a communication between a vehicle and any object that the vehicle that may encounter or affect in its environment.

During operations, information is communicated from the sensors to an on-board computing device 712. The on-board computing device 712 analyzes the data captured by the sensors and optionally controls operations of the vehicle based on results of the analysis. For example, the on-board computing device 712 may control braking via a brake controller 722; direction via a steering controller 724; speed and acceleration via a throttle controller 726 (in a gas-powered vehicle) or a motor speed controller 728 (such as a current level controller in an electric vehicle); a differential gear controller 730 (in vehicles with transmissions); and/or other controllers such as an auxiliary device controller 754.

Geographic location information may be communicated from the location sensor 760 to the on-board computing device 712, which may then access a map of the environment that corresponds to the location information to determine known fixed features of the environment such as streets, buildings, stop signs and/or stop/go signals. Captured images from the cameras 762 and/or object detection information captured from sensors such as a LiDAR system 764 is communicated from those sensors to the on-board computing device 712. The object detection information and/or captured images may be processed by the on-board computing device 712 to detect objects in proximity to the vehicle 701. In addition or alternatively, the vehicle 701 may transmit any of the data to a remote server system 603 (FIG. 1) for processing. Any known or to be known technique for making an object detection based on sensor data and/or captured images can be used in the embodiments disclosed in this document.

In addition, the autonomous vehicle may include an onboard display device (not shown here) that may generate and output interface on which sensor data, vehicle status information, or outputs generated by the processes described in this document (e.g., various maps and routing information) are displayed to an occupant of the vehicle. The display device may include, or a separate device may be, an audio speaker that presents such information in audio format.

The on-board computing device 712 may obtain, retrieve, and/or create map data that provides detailed information about the surrounding environment of the autonomous vehicle 701. The on-board computing device 712 may also determine the location, orientation, pose, etc. of the AV in the environment (localization) based on, for example, three dimensional position data (e.g., data from a GPS), three dimensional orientation data, predicted locations, or the like. For example, the on-board computing device 712 may receive GPS data to determine the AV's latitude, longitude and/or altitude position. Other location sensors or systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise than absolute geographical location. The map data can provide information regarding: the identity and location of different roadways, road segments, lane segments, buildings, or other items; the location, boundaries, and directions of traffic lanes (e.g., the location and direction of a parking lane, a turning lane, a bicycle lane, or other lanes within a particular roadway) and metadata associated with traffic lanes; traffic control data (e.g., the location and instructions of signage, traffic lights, or other traffic control devices); and/or any other map data that provides information that assists the on-board computing device 712 in analyzing the surrounding environment of the autonomous vehicle 701.

In certain embodiments, the map data may also include reference path information that correspond to common patterns of vehicle travel along one or more lanes such that the motion of the object is constrained to the reference path (e.g., locations within traffic lanes on which an object commonly travels). Such reference paths may be pre-defined such as the centerline of the traffic lanes. Optionally, the reference path may be generated based on historical observations of vehicles or other objects over a period of time (e.g., reference paths for straight line travel, lane merge, a turn, or the like).

In certain embodiments, the on-board computing device 712 may also include and/or may receive information relating to the trip or route of a user, real-time traffic information on the route, or the like.

The on-board computing device 712 may include and/or may be in communication with a routing controller 731 that generates a navigation route from a start position to a destination position for an autonomous vehicle. The routing controller 731 may access a map data store to identify possible routes and road segments that a vehicle can travel on to get from the start position to the destination position. The routing controller 731 may score the possible routes and identify a preferred route to reach the destination. For example, the routing controller 731 may generate a navigation route that minimizes Euclidean distance traveled or other cost function during the route, and may further access the traffic information and/or estimates that can affect an amount of time it will take to travel on a particular route. Depending on implementation, the routing controller 731 may generate one or more routes using various routing methods, such as Dijkstra's algorithm, Bellman-Ford algorithm, or other algorithms. The routing controller 731 may also use the traffic information to generate a navigation route that reflects expected conditions of the route (e.g., current day of the week or current time of day, etc.), such that a route generated for travel during rush-hour may differ from a route generated for travel late at night. The routing controller 731 may also generate more than one navigation route to a destination and send more than one of these navigation routes to a user for selection by the user from among various possible routes.

In various embodiments, an on-board computing device 712 may determine perception information of the surrounding environment of the autonomous vehicle 701. Based on the sensor data provided by one or more sensors and location information that is obtained, the on-board computing device 712 may determine perception information of the surrounding environment of the autonomous vehicle 701. The perception information may represent what an ordinary driver would perceive in the surrounding environment of a vehicle. The perception data may include information relating to one or more objects in the environment of the autonomous vehicle 701. For example, the on-board computing device 712 may process sensor data (e.g., LiDAR or RADAR data, camera images, etc.) in order to identify objects and/or features in the environment of autonomous vehicle 701. The objects may include traffic signals, road way boundaries, other vehicles, pedestrians, and/or obstacles, etc. The on-board computing device 712 may use any now or hereafter known object recognition algorithms, video tracking algorithms, and computer vision algorithms (e.g., track objects frame-to-frame iteratively over a number of time periods) to determine the perception.

In some embodiments, the on-board computing device 712 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 712 may perform one or more prediction and/or forecasting operations. For example, the on-board computing device 712 may predict future locations, trajectories, and/or actions of one or more objects. For example, the on-board computing device 712 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the autonomous vehicle 701, the surrounding environment, and/or their relationship(s). For example, if an object is a vehicle and the current driving environment includes an intersection, the on-board computing device 712 may predict whether the object will likely move straight forward or make a turn. If the perception data indicates that the intersection has no traffic light, the on-board computing device 712 may also predict whether the vehicle may have to fully stop prior to enter the intersection.

In various embodiments, the on-board computing device 712 may determine a motion plan for the autonomous vehicle. For example, the on-board computing device 712 may determine a motion plan for the autonomous vehicle based on the perception data and/or the prediction data. Specifically, given predictions about the future locations of proximate objects and other perception data, the on-board computing device 712 can determine a motion plan for the autonomous vehicle 701 that best navigates the autonomous vehicle relative to the objects at their future locations.

In one or more embodiments, the on-board computing device 712 may receive predictions and make a decision regarding how to handle objects and/or actors in the environment of the autonomous vehicle 701. For example, for a particular actor (e.g., a vehicle with a given speed, direction, turning angle, etc.), the on-board computing device 712 decides whether to overtake, yield, stop, and/or pass based on, for example, traffic conditions, map data, state of the autonomous vehicle, etc. Furthermore, the on-board computing device 712 also plans a path for the autonomous vehicle 701 to travel on a given route, as well as driving parameters (e.g., distance, speed, and/or turning angle). That is, for a given object, the on-board computing device 712 decides what to do with the object and determines how to do it. For example, for a given object, the on-board computing device 712 may decide to pass the object and may determine whether to pass on the left side or right side of the object (including motion parameters such as speed). The on-board computing device 712 may also assess the risk of a collision between a detected object and the autonomous vehicle 701. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 712 may execute one or more control instructions to perform a cautious maneuver (e.g., mildly slow down, accelerate, change lane, or swerve). In contrast, if the collision cannot be avoided, then the on-board computing device 712 may execute one or more control instructions for execution of an emergency maneuver (e.g., brake and/or change direction of travel).

As discussed above, planning and control data regarding the movement of the autonomous vehicle is generated for execution. The on-board computing device 712 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

In the various embodiments discussed in this document, the description may state that the vehicle or a controller included in the vehicle (e.g., in an on-board computing system) may implement programming instructions that cause the vehicle and/or a controller to make decisions and use the decisions to control operations of the vehicle. However, the embodiments are not limited to this arrangement, as in various embodiments the analysis, decision making and/or operational control may be handled in full or in part by other computing devices that are in electronic communication with the vehicle's on-board computing device and/or vehicle control system. Examples of such other computing devices include an electronic device (such as a smartphone) associated with a person who is riding in the vehicle, as well as a remote server that is in electronic communication with the vehicle via a wireless communication network. The processor of any such device may perform the operations that will be discussed below.

Referring back to FIG. 6, the communications interface 614 may be configured to allow communication between autonomous vehicle 601 and external systems, such as, for example, external devices, sensors, other vehicles, servers, data stores, databases etc. Communications interface 614 may utilize any now or hereafter known protocols, protection schemes, encodings, formats, packaging, etc. such as, without limitation, Wi-Fi, an infrared link, Bluetooth, etc. User interface system 616 may be part of peripheral devices implemented within a vehicle 601 including, for example, a keyword, a touch screen display device, a microphone, and a speaker, etc.

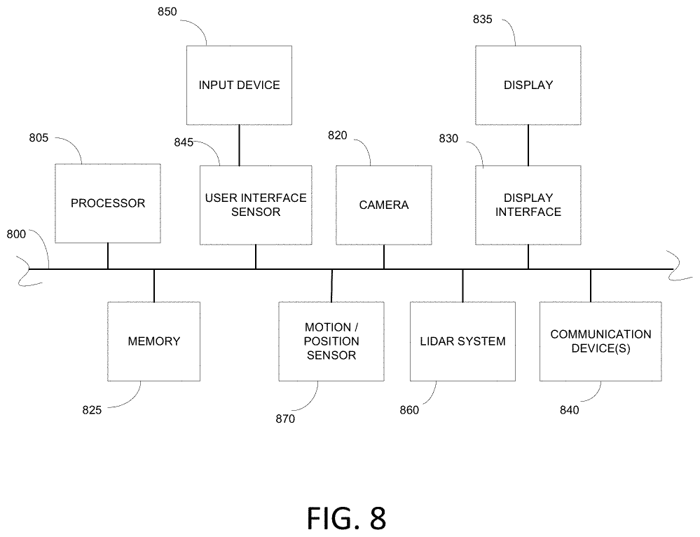

FIG. 8 depicts an example of internal hardware that may be included in any of the electronic components of the system, such as internal processing systems of the AV, external monitoring and reporting systems, or remote servers. An electrical bus 800 serves as an information highway interconnecting the other illustrated components of the hardware. Processor 805 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 825. A memory device may include a single device or a collection of devices across which data and/or instructions are stored. Various embodiments of the invention may include a computer-readable medium containing programming instructions that are configured to cause one or more processors to perform the functions described in the context of the previous figures.

An optional display interface 830 may permit information from the bus 800 to be displayed on a display device 835 in visual, graphic or alphanumeric format, such on an in-dashboard display system of the vehicle. An audio interface and audio output (such as a speaker) also may be provided. Communication with external devices may occur using various communication devices 840 such as a wireless antenna, a radio frequency identification (RFID) tag and/or short-range or near-field communication transceiver, each of which may optionally communicatively connect with other components of the device via one or more communication system. The communication device(s) 840 may be configured to be communicatively connected to a communications network, such as the Internet, a local area network or a cellular telephone data network.

The hardware may also include a user interface sensor 845 that allows for receipt of data from input devices 850 such as a keyboard or keypad, a joystick, a touchscreen, a touch pad, a remote control, a pointing device and/or microphone. Digital image frames also may be received from a camera 820 that can capture video and/or still images. The system also may receive data from a motion and/or position sensor 880 such as an accelerometer, gyroscope or inertial measurement unit. The system also may receive data from a LiDAR system 860 such as that described earlier in this document.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

Terminology that is relevant to the disclosure provided above includes:

An “automated device” or “robotic device” refers to an electronic device that includes a processor, programming instructions, and one or more components that based on commands from the processor can perform at least some operations or tasks with minimal or no human intervention. For example, an automated device may perform one or more automatic functions or function sets. Examples of such operations, functions or tasks may include without, limitation, navigation, transportation, driving, delivering, loading, unloading, medical-related processes, construction-related processes, and/or the like. Example automated devices may include, without limitation, autonomous vehicles, drones and other autonomous robotic devices.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. Autonomous vehicles also include vehicles in which autonomous systems augment human operation of the vehicle, such as vehicles with driver-assisted steering, speed control, braking, parking and other systems.

In this document, the terms “street,” “lane” and “road” are illustrated by way of example with vehicles traveling on one or more roads. However, the embodiments are intended to include lanes and roads in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” may represent an airway and a lane may be a portion of the airway. If the autonomous vehicle is a watercraft, then the term “street” may represent a waterway and a lane may be a portion of the waterway.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The term “object”, when referring to an object that is detected by a vehicle perception system or simulated by a simulation system, is intended to encompass both stationary objects and moving (or potentially moving) actors, except where specifically stated otherwise by terms use of the term “actor” or “stationary object.” As used herein, uncertain road users may include pedestrians, cyclists, individuals on roller skates, rollerblades, wheelchairs, individuals, or people in general, etc.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, when relative terms of order such as “first” and “second” are used to modify a noun, such use is simply intended to distinguish one item from another, and is not intended to require a sequential order unless specifically stated.

In addition, terms of relative position such as “vertical” and “horizontal”, or “front” and “rear”, when used, are intended to be relative to each other and need not be absolute, and only refer to one possible position of the device associated with those terms depending on the device's orientation. When this document uses the terms “front,” “rear,” and “sides” to refer to an area of a vehicle, they refer to areas of vehicle with respect to the vehicle's default area of travel. For example, a “front” of an automobile is an area that is closer to the vehicle's headlamps than it is to the vehicle's tail lights, while the “rear” of an automobile is an area that is closer to the vehicle's tail lights than it is to the vehicle's headlamps. In addition, the terms “front” and “rear” are not necessarily limited to forward-facing or rear-facing areas but also include side areas that are closer to the front than the rear, or vice versa, respectively. “Sides” of a vehicle are intended to refer to side-facing sections that are between the foremost and rearmost portions of the vehicle.

1. A system for controlling navigation of an autonomous vehicle, the system comprising:
a processor; and
a non-transitory computer readable medium comprising one or more programming instructions that, when executed by the processor, will cause the processor to:
receive information relating to a geonet that represents a portion of a map area within which an autonomous vehicle is allowed to operate, the geonet comprising a plurality of geo-coordinate pairs, each of the plurality of geo-coordinate pairs being indicative of a start location and an end location of each of a plurality of geonet elements in the geonet,
receive a lane-level map comprising a plurality of lane segments corresponding to the map area,
for each of the plurality of lane segments:
identify a match geonet element from the plurality of geonet elements,
determine a match distance between the match geonet element and that lane segment, and
select that lane segment for inclusion in the geonet upon determining that the match distance is less than a threshold distance,
generate, using one or more lane segments selected for inclusion in the geonet, an updated lane-level map that includes the geonet, and
cause the autonomous vehicle to navigate between an origin location and a destination location within the geonet by generating, using the updated lane-level map, a trajectory between the origin location and the destination location.

2. The system of claim 1, further comprising programming instruction that, when executed by the processor, will cause the processor to:
create a data representation of the geonet that includes an indication of the one or more lane segments selected for inclusion in the geonet; and
add the data representation to a low definition map comprising the geonet for creation of the updated lane-level map within the low definition map.

3. The system of claim 1, wherein the programming instructions to, for each of the plurality of lane segments, identify the match geonet element from the plurality of geonet elements comprise programming instructions that when executed by the processor, will cause the processor to identify a geo-coordinate that forms a mid-point of that lane segment.

4. The system of claim 3, wherein the programming instructions to, for each of the plurality of lane segments, identify the match geonet element from the plurality of geonet elements comprise programming instructions that when executed by the processor, will cause the processor to:
identify, using a spatial search algorithm, a plurality of candidate geonet elements that are within a first threshold distance of that lane segment;
determine a candidate match distance between each of the plurality of candidate geonet elements and that lane segment;
identify a candidate geonet element of the plurality of candidate geonet elements that has the least candidate match distance; and
determine that the candidate geonet element is the match geonet element.

5. The system of claim 4, wherein the programming instructions to determine the candidate match distance between each of the plurality of candidate geonet elements and that lane segment comprise programming instructions that, when executed by the processor, will cause the processor to determine the candidate match distance for a candidate geonet element as an average of the following:
an angular distance between a centerline of that lane segment and that candidate geonet element;
a perpendicular distance between the geo-coordinate of that lane segment and an infinite line defined by that geonet element; and
a lengthwise minimum distance along a line computed as the projection of the geo-coordinate of that lane segment onto the infinite line defined by that geonet element to each of that geonet element's endpoints.

6. The system of claim 1, further comprising programming instructions that, when executed by the processor, will cause the processor to:
cluster the one or more lane segments selected for inclusion in the geonet into logical groupings that form a plurality of undirected streets; and
for each of the plurality of undirected streets:
determine a median match distance as an average of match distances of all the lane segments that form that street,
determine whether the median match distance is greater than a second threshold distance, and
determine, when the median match distance is greater than the second threshold distance that all the lane segments that form that street should not be included in the geonet.

7. The system of claim 6, further comprising programming instructions that, when executed by the processor, will cause the processor to determine, when the median match distance is less than the second threshold distance that all the lane segments that form that street will be included in the geonet.

8. The system of claim 6, wherein the programming instructions to cluster the one or more lane segments selected for inclusion in the geonet into logical groupings that form the plurality of undirected streets comprise programming instructions to cause the processor to perform at least one of the following:
merge one or more lane segments to create road segments;
replace one or more lane segments with a single lane required to span a street perpendicular to traffic; or
merge road segments parallel with traffic.

9. The system of claim 1, further comprising programming instructions that, when executed by the processor, will cause the processor to:
identify a subset of the one or more lane segments selected for inclusion in the geonet as strongly connected lane segments by:
creating a routing graph using the one or more lane segments selected for inclusion in the geonet, and
identifying a strongly connected component of the routing graph; and
use only the identified subset for generating the updated lane-level map.

10. The system of claim 1, wherein each of the plurality of lane segments is represented as a polygon within the lane-level map.

11. A method for controlling navigation of an autonomous vehicle, the method comprising, by a processor:
receiving information relating to a geonet that represents a portion of a map area within which an autonomous vehicle is allowed to operate, the geonet comprising a plurality of geo-coordinate pairs, each of the plurality of geo-coordinate pairs being indicative of a start location and an end location of each of a plurality of geonet elements in the geonet,
receiving a lane-level map comprising a plurality of lane segments corresponding to the map area,
for each of the plurality of lane segments:
identifying a match geonet element from the plurality of geonet elements,
determining a match distance between the match geonet element and that lane segment, and
selecting that lane segment for inclusion in the geonet upon determining that the match distance is less than a threshold distance,
generating, using one or more lane segments selected for inclusion in the geonet, an updated lane-level map that includes the geonet, and
causing the autonomous vehicle to navigate between an origin location and a destination location within the geonet by generating, using the updated lane-level map, a trajectory between the origin location and the destination location.

12. The method of claim 11, further comprising:
creating a data representation of the geonet that includes an indication of the one or more lane segments selected for inclusion in the geonet; and
adding the data representation to a low definition map comprising the geonet for creation of the updated lane-level map within the low definition map.

13. The method of claim 11, wherein, for each of the plurality of lane segments, identifying the match geonet element from the plurality of geonet elements comprises identifying a geo-coordinate that forms a mid-point of that lane segment.

14. The method of claim 13, wherein, for each of the plurality of lane segments, identifying the match geonet element from the plurality of geonet elements comprises:
identifying, using a spatial search algorithm, a plurality of candidate geonet elements that are within a first threshold distance of that lane segment;
determining a candidate match distance between each of the plurality of candidate geonet elements and that lane segment;
identifying a candidate geonet element of the plurality of candidate geonet elements that has the least candidate match distance; and
determining that the candidate geonet element is the match geonet element.

15. The method of claim 14, wherein determining the candidate match distance between each of the plurality of candidate geonet elements and that lane segment comprises determining the candidate match distance for a candidate geonet element as an average of the following:
an angular distance between a centerline of that lane segment and that candidate geonet element;
a perpendicular distance between the geo-coordinate of that lane segment and an infinite line defined by that geonet element; and
a lengthwise minimum distance along a line computed as the projection of the geo-coordinate of that lane segment onto the infinite line defined by that geonet element to each of that geonet element's endpoints.

16. The method of claim 11, further comprising:
clustering the one or more lane segments selected for inclusion in the geonet into logical groupings that form a plurality of undirected streets; and
for each of the plurality of undirected streets:
determining a median match distance as an average of match distances of all the lane segments that form that street,
determining whether the median match distance is greater than a second threshold distance, and
determining, when the median match distance is greater than the second threshold distance that all the lane segments that form that street should not be included in the geonet.

17. The method of claim 16, further comprising determining, when the median match distance is less than the second threshold distance that all the lane segments that form that street will be included in the geonet.

18. The method of claim 16, wherein clustering the one or more lane segments selected for inclusion in the geonet into logical groupings that form the plurality of undirected streets comprises performing at least one of the following:
merging one or more lane segments to create road segments;
replacing one or more lane segments with a single lane required to span a street perpendicular to traffic; or
merging road segments parallel with traffic.

19. The method of claim 11, further comprising:
identifying a subset of the one or more lane segments selected for inclusion in the geonet as strongly connected lane segments by:
creating a routing graph using the one or more lane segments selected for inclusion in the geonet, and
identifying a strongly connected component of the routing graph; and
use only the identified subset for generating the updated lane-level map.

20. The method of claim 11, wherein each of the plurality of lane segments is represented as a polygon within the lane-level map.
